(19) United States
(12) Patent Application Publication
(10) Pub. No.: US 2014/0089335 A1
(43) Pub. Date: Mar. 27, 2014

(54) SYSTEM FOR VERIFYING A PLACE WHERE BUSINESS DATA ARE BROWSED

(71) Applicant: OKI ELECTRIC INDUSTRY CO., LTD., Tokyo (JP)

(72) Inventor: Yasuhiro KAWAKITA, Tokyo (JP)

(73) Assignee: OKI ELECTRIC INDUSTRY CO., LTD., Tokyo (JP)

(21) Appl. No.: 13/886,362

(22) Filed: May 3, 2013

(30) Foreign Application Priority Data
Sep. 24, 2012 (JP) 2012-209725

(51) Int. Cl. G06F 17/30

(52) U.S. Cl. CPC G06F 17/30129
USPC 707/758

(57) ABSTRACT

A server includes a collector which collects browsing positional information of a file from a user terminal device; a matching unit which checks matching of the collected browsing positional information with authenticated browsing positional information of the file; and an outputter which outputs a result of the checking performed by the matching unit.

### BACKGROUND OF THE INVENTION

1. Field of the Invention

The present invention relates to a data browsing system, and more particularly to a server managing business data, and a user terminal device serving business data.

2. Description of the Background Art

In recent years, mobile terminal devices have spread quickly, and may be used especially in situations where business persons visiting destinations and on business trips. For example, mobile terminal devices, such as laptop personal computers (PCs), personal digital assistants (PDA), tablet terminal devices, smartphones and cellular phones, are utilized for business. Especially the volume of shipment of smartphones increases year by year, and smartphones are utilized in many situations such as of presenting explanatory or proposal materials of commercial products to customers at customers' offices, and of reviewing explanatory materials or schedules on the way to visiting destinations.

In conventional systems, when a user is away from his or her office, he or she uses a mobile terminal device to access a database or the like in the office to acquire required business data. Regarding analysis of an access to information, various solutions have been proposed.

For example, U.S. Pat. No. 7,107,149 B2 to Kubota proposes a solution in which positional information on a place where specific information is retrieved or browsed is acquired to be stored with the retrieved information as history information, and the browsing place is indicated on a map to be presented. By this means, an information provider could immediately understand at which place the retrieved information is required.

In addition, Japanese patent laid-open publication No. 2003-44626 to Sato proposes a solution in which it is counted area by area how many times information is downloaded over a telecommunications network, and resultant counts are presented on a map to output.

Furthermore, US patent application publication No. US 2004/0190715 A1 to Nimura et al proposes a solution in which data are encrypted and stored by using positional information as a key. When opening an encrypted file, it is necessary to decrypt the file by means of information on a position designated at the time of storing the data. It is therefore possible to avoid the file to be opened at places other than the designated place.

However, the solutions proposed in Kubota and Sato are directed to simply collecting positional information of terminal devices which have accessed data. The solution proposed in Nimura is inconvenient since a file cannot be opened at places other than a designated place.

All of the above-described patent publications are silent about statistics of places at which a mobile terminal views data locally stored therein, and verification on an actual browsing place against an authenticated browsing place.

### SUMMARY OF THE INVENTION

It is therefore an object of the present invention to provide a user terminal device and a server for use in a new and improved system for verifying a place or position where business data are browsed on a user terminal device.

In accordance with the present invention, there is provided a server including: a collector which collects browsing positional information of a file from a user terminal device; a matching unit which checks matching of the collected browsing positional information with authenticated browsing positional information of the file to produce a matching result representative of a result of checking; and an output unit which outputs the matching result.

The matching result may be displayed on a map at a position where the file was accessed with at least either of the browsing positional information matching the authenticated browsing positional information and the browsing positional information not matching the authenticated browsing positional information.

The collector may collect viewer information of a viewer accessing the file. For each viewer, the matching result may be displayed on the map. The matching result may be displayed for each file.

The file may be tagged with a keyword, and the matching result may be displayed for each keyword.

The file may include data regarding business of a sales product, and the matching result may be displayed together with information of an order received on the product.

In accordance with the present invention, there is provided a user terminal device including: a browsing controller operative in response to operation of a user for controlling browsing of a file; a positional information acquisition unit which acquires current positional information representative of a position where the file is browsed by the user terminal device; and a transmission controller which controls the positional information acquisition unit to transmit the current positional information to a server as browsing positional information on the file.

The user terminal device may receive the matching result from the server. The user terminal device may further include a display controller which uses the matching result to display on the map at a position where the file was accessed with at least either of the browsing positional information matching the authenticated browsing positional information and the browsing positional information not matching the authenticated browsing positional information.

Further in accordance with the present invention, there is provided a non-transitory computer-readable storage medium storing a program for causing a computer to function as the server. Still further in accordance with the present invention, there is also provided a non-transitory computer-readable storage medium storing a program for causing a computer to function as the user terminal device.

According to the present invention, it is thus possible to output a matching result representative of information on a position or place where business data were browsed.

The inventive concept disclosed in the application may also be defined in ways other than in the claims presented below. The inventive concept may consist of several separate inventions particularly if the invention is considered in light of explicit or implicit subtasks or from the point of view of advantages achieved. In such a case, some of the attributes included in the claims may be superfluous from the point of view of separate inventive concepts. Within the framework of the basic inventive concept, features of different embodiments are applicable in connection with other embodiments.

### BRIEF DESCRIPTION OF THE DRAWINGS

The objects and features of the present invention will become more apparent from consideration of the following detailed description taken in conjunction with the accompanying drawings in which:

FIG. 1 schematically illustrates the overall configuration of a business data browsing system according to a preferred embodiment of the present invention;

FIG. 2 is a schematic block diagram illustrating the configuration of the management server in the illustrative embodiment shown in FIG. 1;

FIG. 3 illustrates an example of data stored in an authenticated browsing positional information storage in the illustrative embodiment;

FIG. 4 illustrates an example of data stored in abrowsing history storage in the illustrative embodiment;

FIG. 5 is a schematic block diagram illustrating the constitution of a client terminal device in the illustrative embodiment;

FIG. 6 is a flowchart useful for understanding the acquisition process of business data in the illustrative embodiment;

FIG. 7 is a flowchart useful for understanding the process of collecting information on positions of browsing business data in the illustrative embodiment;

FIG. 8 is a flowchart useful for understanding a matching process in the illustrative embodiment; and

FIGS. 9 through 11 illustrate display examples of a matching result in the illustrative embodiment.

### DESCRIPTION OF THE PREFERRED EMBODIMENT

Now, a preferred embodiment of the present invention will be described in detail, referring to the accompanying drawings. Throughout this patent application, like components or constituent elements are designated with the same reference numerals, and repetitive description will be avoided.

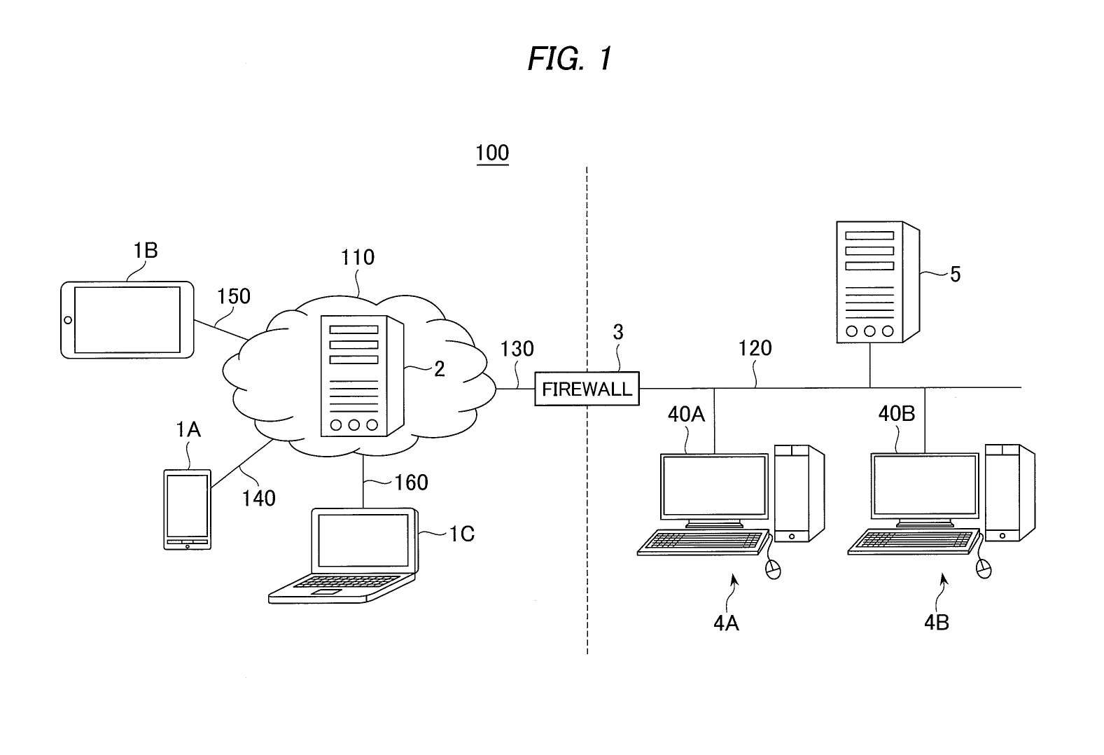

FIG. 1 schematically illustrates the overall configuration of a business data browsing system 100 according to an illustrative embodiment of the present invention. As can be seen from FIG. 1, the business data browsing system 100 includes client terminal devices, for example, user terminal devices, 1A, 1B and 1C and a management server 2. The management server 2 is connected to the Internet 110 and an intranet 120 through a firewall 3. The intranet 120 may be a local area network (LAN) installed in the premises of a business entity, such as company, and includes, for example, plural company personal computers (PCs) 4A and 4B, and a company server 5 interconnected to the intranet 120.

Note that, when it is not necessary to distinguish the specific client terminal devices 1A, 1B and 1C from each other, the terminal devices may generally be designated with a simple reference numeral 1. Similarly, when it is not necessary to distinguish the specific company personal computers 4A and 4B from each other, and also the display units 40A and 40B of the company personal computers from each other, the company personal computers and the display units may be designated with respective, general reference numerals 4 and 40.

In the system 100 shown in FIG. 1, the firewall (FW) 3 controls communication with the outside, and ensures the security of the internal computer network, i.e. intranet 120. In the intranet 120, business data are processed by the company personal computers 4 and stored in the companypersonal computers 4 or the company server 5. The user can operate the company personal computers 4 and can upload desired business data to the management server 2. In the context, the term “business data” may cover in a broader sense any possibilities of including user data that may be confidential to a limited person or persons and/or effective to access, such as review, browse or display, at a limited time or period of time, place, or occasion. Similarly, the word “company” covers any forms of entities established by plural persons, including public entities.

The client terminal devices 1A and 1B, which may be mobile terminals, such as smartphone and tablet terminal device, respectively, may be connected to the management server 2, for example through 3G public telecommunications network and a VPN (Virtual Private Network) server, not shown, or via wireless LAN (Local Area Network) connection. The client terminal device 1C, which may be a laptop personal computer, may be connected to the management server 2 through the Internet 110, or via wireless LAN connection.

In this way, each client terminal device 1 can be connected to the management server 2 to acquire business data stored in the management server 2. By this means, the user can manipulate the client terminal device 1 outside his or her office to access, e.g. browse, desired business data.

The conventional solutions described earlier did not consider the management of a place at which a file downloaded to, and stored in, a client terminal device is browsed. In addition, in the conventional solutions, it was not possible to verify whether or not business data in question are browsed at an authenticated place.

In view of the above difficulty in the conventional solutions, the business data browsing system 100 in accordance with the illustrative embodiment is adapted to check whether or not positional information representative of a position or place at which business data are/were browsed is matched with positional information representing a position or place at which the business data are authenticated to be browsed to output a matching result representative of the result of the checking. The former positional information indicates a position or place in which the user browses a file in question, and may be referred to as “browsing positional information” of business data. The latter positional information indicates a position with which a file in question is provided and at which the file is allowed to be browsed, or accessed, and may be referred to “authenticated browsing positional information”. The authenticated browsing positional information may include, for example, spot names, numerical data such as latitude and longitude, and positional expressions such as the name of an administrative district. Accordingly, it is possible to confirm whether intended business data are browsed only at a specified place, whether business data which should be presented at a specified place are presented at that place, whether an appropriate user browses required business data, and so on.

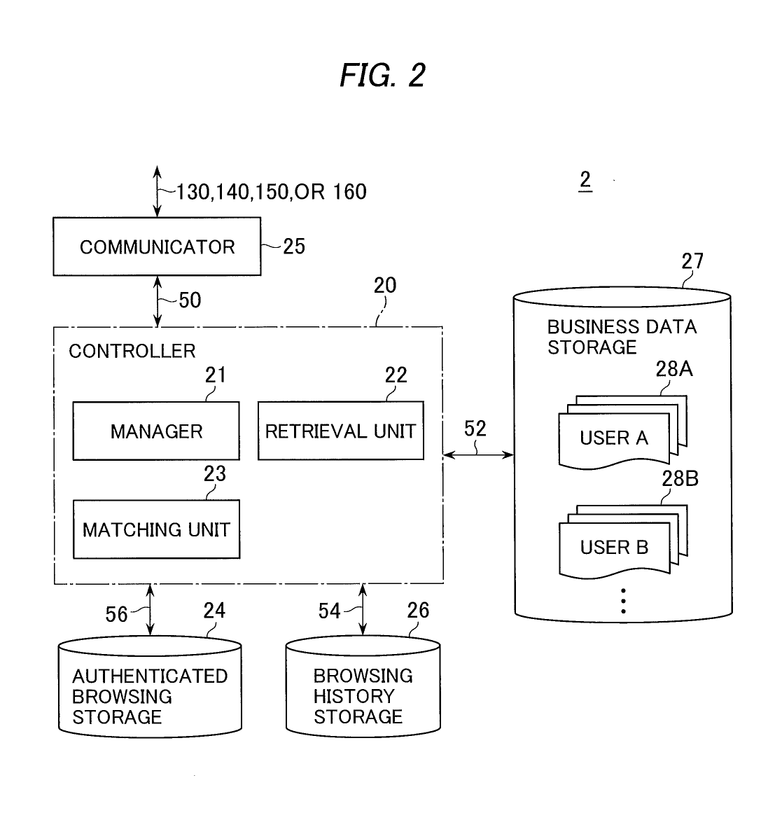

Now, the basic configuration of the management server 2 and the client terminal device 1 included in the business data browsing system 100 in the preferred embodiment will be described. FIG. 2 is a schematic block diagram illustrating the configuration of the management server 2 in the present embodiment. As shown, the management server 2 includes a controller 20, a communicator 25, an authenticated browsing storage 24, a browsing history storage 26 and a business data storage 27. The three storages 24, 26 and 27 function as databases.

The communicator 25 has the function of establishing a communication connection with an external device to transmit or receive data 50. Signals or data are designated with reference numerals of connections on which they are conveyed. The communicator 25 in the illustrative embodiment receives business data 130 through the firewall 3, for example, from the company personal computers 4 included in the intranet 120. The communicator 25 is also operative in response to requests from the client terminal devices 1 to transmit business data 130 or the like to the client terminal devices 1.

In addition, the communicator 25 in the illustrative embodiment also functions as a collector adapted to collect data 140, 150 and 160 indicating which information the client terminal devices 1 have presented and where the client terminal devices 1 have presented the information. Specifically, the communicator 25, i.e. collector, receives the browsing positional information of business data, or file, 140, 150 and 160 from the client terminal device 1.

The communicator 25 also functions as an outputter serving to output or transmit the matching result 50 obtained by the matching unit 23 described below to the client terminal devices 1 or company personal computers 4.

The controller 20 is adapted to control the constituent components of the management server 2. More specifically, the controller 20 in the illustrative embodiment includes a manager 21 which manages business data 52 so as to store the business data 52 specific for users in the business data storage 27, a retrieval unit 22 which retrieves the data 52 in the business data storage 27 in response to requests from the client terminal devices 1, and a matching unit 23 which checks whether to match the browsing positional information of the business data 52.

The manager 21 manages the storage of the business data 52 uploaded as business data 50 by the users from the intranet 12 through the communicator 25 in folders in the business data storage 27 for the respective users. In this case, the manager 21 may be adapted to tag the business data 50 concerned with keywords or indices extracted from the business data 50 to store the business data thus tagged in the folders of the business data storage 27. The keywords may be, for example, proper nouns such as a company names and a products' names, position expression such as spot names and addresses, telephone numbers, email addresses, and so on. The manager 21 may reference a dictionary or directory database, not shown, which stores keywords for tagging in advance, to thereby extract such keywords.

In addition, the manager 21 associates the browsing positional information 50 received from the client terminal device 1 through the communicator 25 with identification information, e.g. filename, of browsed business data, and stores resultant information 54 in the browsing history storage 26.

The retrieval unit 22 is adapted to search the business data storage 27 for appropriate business data 52 from in accordance with an acquisition request from the client terminal devices 1. More specifically, the retrieval unit 22 uses file names, tags or keywords which are included in acquisition requests to search for business data appropriate for the requests. The business data 50 retrieved by the retrieval unit 22 are transmitted to the client terminal devices 1 which have originated the requests through the communicator 25.

The retrieval unit 22 may be adapted to transmit, when the retrieval unit 22 retrieves a plurality of business data items by means of tags, a list of the plurality of business data items to the client terminal devices 1 through the communicator 25 as a search result.

The matching unit 23 is adapted to check or determine whether or not browsing positional information of each item of the business data 54 stored in the browsing history storage 26 is matched with the authenticated browsing positional information of the appropriate item of the business data 56 stored in the authenticated browsing positional information storage 24 to output a matching result representative of the checking included in the business data 50. The matching result may be presented in the form of display on a map at a position or place where, for example, the file or business data are/were browsed or viewed, i.e. accessed, with at least either of the browsing positional information matching the authenticated browsing positional information and the browsing positional information not matching the authenticated browsing positional information.

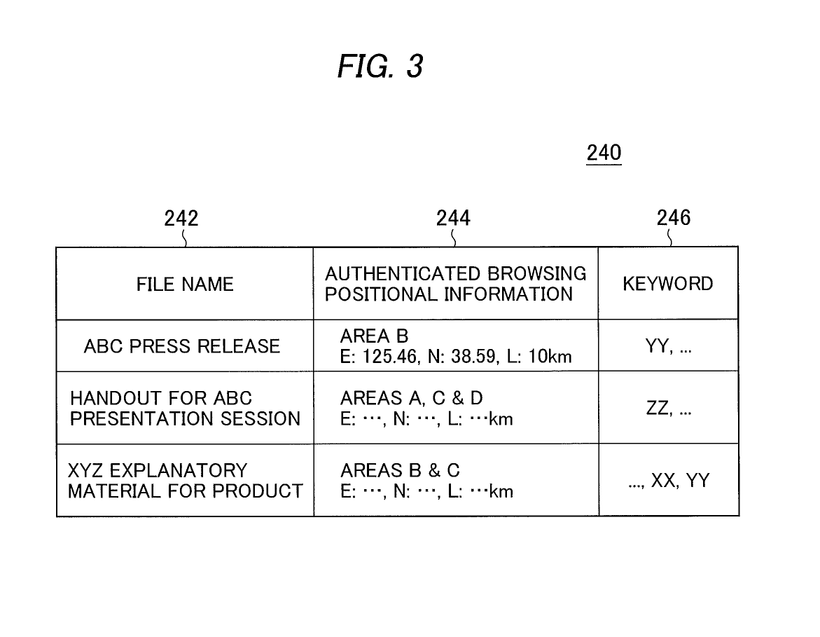

The authenticated browsing storage 24 stores the authenticated browsing positional information 56 which indicates authenticated positions at which the business data concerned are allowed to be browsed. The authenticated browsing positional information 56 of the business data 50 may be input in advance by an administrator or the like. FIG. 3 illustrates an example of data 56 stored in the authenticated browsing storage 24. As seen from the figure, the authenticated browsing storage 24 stores authenticated browsing positional information 240 including the file names 242, authenticated browsing positional information 244 and tagging keywords 246 which are associated with each other in respect of each item of business data. The authenticated browsing positional information 240 may be of the form expressing positions, for example, positional expression such as an address and a spot name, numeric expression such as latitude and longitude, the areal name of a region, e.g. the name of an administrative district, or the like. The example illustrated in FIG. 3 uses the names of administrative regions, such as A, B, C and D, and numeric expression of latitude and longitude and so on, such as 38.59 N (North), 125.46 E (East), and 10 km L (Length, i.e. distance).

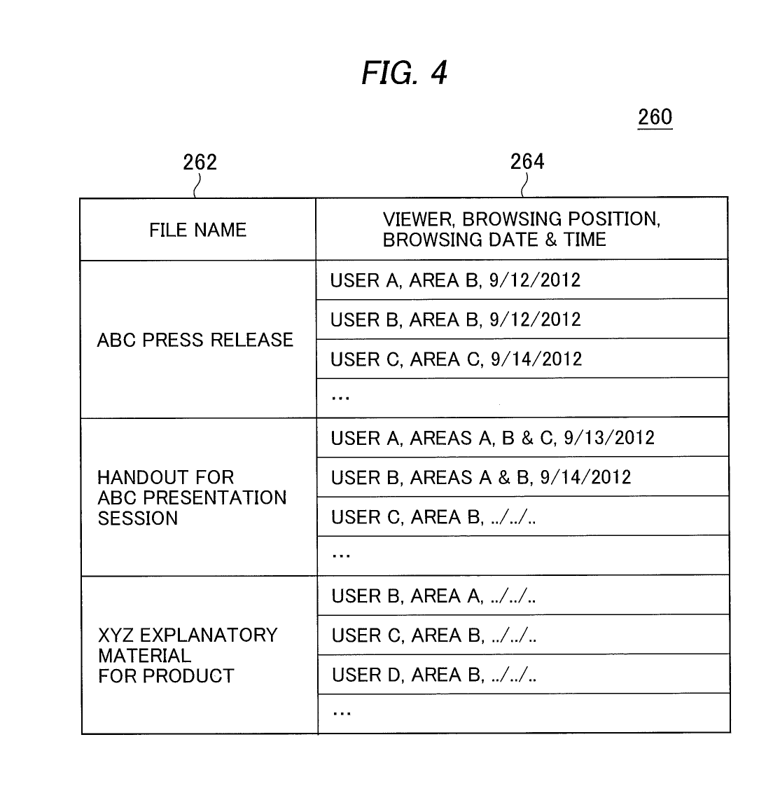

The browsing history storage 26 stores the history information 54 on users who browsed business data, positions at which the users browsed business data, and dates and times at which the users browsed. FIG. 4 illustrates an example of data stored in the browsing history storage 26. As depicted in the figure, the browsing history storage 26 stores the history information 260 including the file names 262 of business data, and viewers, browsing positions and browsing dates and times 264 associated with the business data.

The business data storage 27 stores the business data 52 uploaded from the users on a user-by-user basis. For example, as illustrated in FIG. 2, the business data storage 27 stores plural business data items 28A for the user A and plural business data items 28B for the user B.

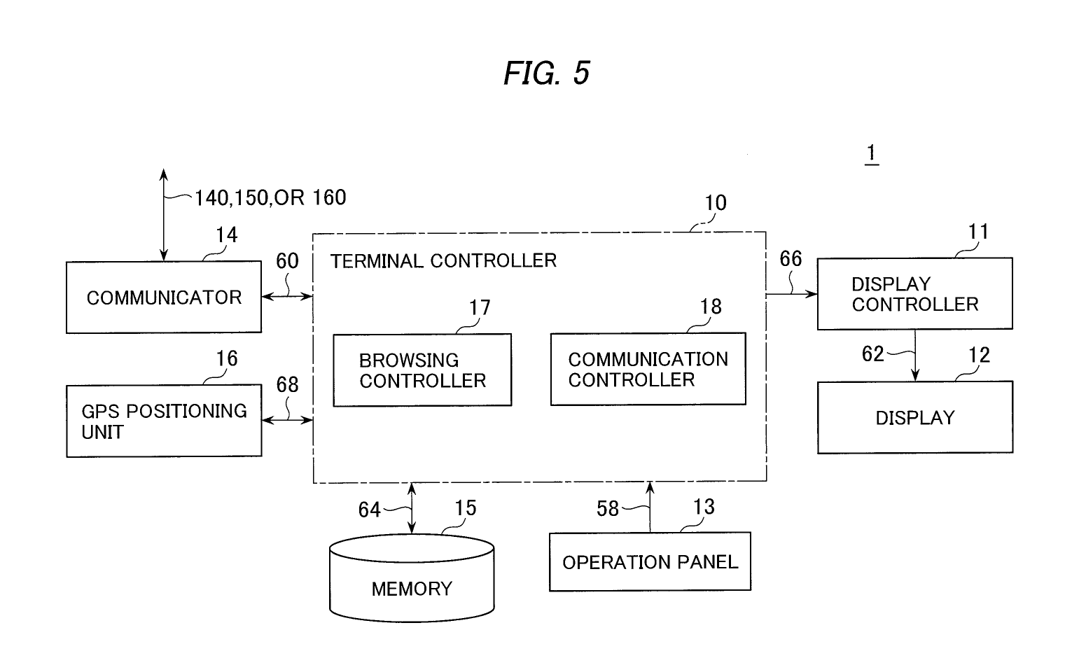

In the above, the specific configuration of management server 2 in the illustrative embodiment has been described. Next, with reference to FIG. 5, a specific constitution of the client terminal device 1 in the embodiment will be described.

The client terminal devices, or user terminal devices, 1 in the illustrative embodiment are a mobile type of information processing devices, and may be utilized by the user outside the company. The client terminal devices 1 may be any of various types of devices, such as a smartphone, a laptop personal computer, and a tablet terminal device as illustrated in FIG. 1. The following description will be focused on the principal components common to such a verity of devices applicable to the client terminal devices 1.

FIG. 5 is a schematic block diagram illustrating the configuration of the client terminal devices 1 in the illustrative embodiment. As seen from the figure, the client terminal device 1 includes a controller 10, a display controller 11, a display 12, an operation panel 13, a communicator 14, a memory 15, and a GPS (Global Positioning System) positioning unit 16.

The terminal controller 10 functions as controlling the components of the client terminal device 1. For example, the terminal controller 10 controls those components in response to a user operation 58 made on the operation panel 13. The terminal controller 10 is also responsive to the user operation 60 to send a business data acquisition request 140, 150 or 160 to the management server 2 from the communicator 14. The business data acquisition request 140, 150 or 160 is for use in acquiring business data to be stored in the client terminal devices 1, and includes, for example, the file name and tag information of business data. The terminal controller 10 may be adapted to acquire from the management server 2 a list 60 of business data 140, 150 or 160 of the user that he or she has stored in the business data storage 27 of the management server 2 on the intranet 120 to display the list 62 on the display 12. The terminal controller 10 may prompt the user to select business data 60 on the list thus displayed.

The terminal controller 10 in the illustrative embodiment includes, as shown in FIG. 5, a browsing controller 17 and a communication controller 18.

The browsing controller 17 is responsive to a browsing operational instruction for the business data 58 being entered on the operation panel 13 to perform a browsing control outputting an instruction 66 to cause the display controller 11 to display the business data 64 stored or held in the memory 15 on the display 12. The browsing operational instruction 58 for business data may be an instruction generated, for example, in response to the user touching the display 12 at the file name of the business data 62 displayed thereon or the like.

The communication controller 18 controls the communicator 14 to transmit and receive data 60. The communication controller 18 in the illustrative embodiment functions as a transmission controller which controls the communicator 14 to transmit, when the browsing controller 17 controls the browsing of business data, information on the current position of the client terminal device 1 to the management server 2 as browsing positional information of business data 140, 150 or 160. The information 68 on the current positions of the client terminal devices 1 is acquired by the GPS positioning unit 16 described below.

In this way, in the illustrative embodiment, when the browsing of business data is controlled by the display control performed on the display 12 through the display controller 11, the client terminal device 1 transmits to the management server 2 browsing positional information 68 on which business data and where the data were browsed. When the terminal 1 is offline, the terminal controller 10 stores the browsing positional information 64 temporarily in the memory 15, and when the terminal 1 shifts itself to its online state, it transmits the browsing positional information 64 thus stored to the management server 2. Note that the communication controller 18 may transmit, together with the browsing positional information 64, browsing time information on time at which business data were browsed.

The display controller 11 controls the display 12 to display various images or windows thereon. More specifically, the display controller 11 in the illustrative embodiment is operative in response to instructions 66 from the browsing controller 17 to control the display 12 to display business data 62 there on. The display controller 11 is also adapted to be responsive in response to the operation of the user received by the operation panel 13 to control the display screen.

The display 12 is a visual display device having its display screen, or viewing area, on which a variety of display images or windows may be displayed under the control of display controller 11. The display 12 may be implemented by a liquid crystal display (LCD), organic light-emitting diode (OLED) display, a cathode-ray tube (CRT) or the like.

The operation panel 13 is a device for sensing the operation of the user, and may be implemented by, for example, a touch panel, buttons, switches, a keyboard and/or keypad, and/or a pointing device such as a mouse, and so on.

In the memory 15, there may be stored various program sequences for controlling the terminal controller 10 to execute processes. The memory 15 may be implemented by a ROM (Read Only Memory), a RAM (Random. Access Memory), an HDD (Hard Disk Drive) or the like.

The GPS positioning unit 16 is adapted to receive signals from plural GPS satellites through the communicator 14 to measure the current position of the terminal 1. Note that the GPS positioning unit 16 is an example of the positional information acquisition unit which obtains information on a current position where the client terminal device 1 in question currently stays, and may not be limited to the GPS type of positioning unit 16. For example, the positional information acquisition unit may be of a type of measuring the current position of the terminal 1 by utilizing information on a base station or stations on a mobile network, or by obtaining current positional information through a connection to a nearby access point by a wireless LAN, such as Wi-Fi (Wireless Fidelity) connection or the like.

In the above, the components of the management server and the client terminal devices 1 in the illustrative embodiment has been described in detail. Next, it will be specifically described how the browsing system 100 operates according to the illustrative embodiment.

With the browsing system 100 of the illustrative embodiment, an acquisition process of business data and a browsing positional information collecting process are performed. In the acquisition process of business data, the client terminal device 1 to be carried out to outside the company acquires business data uploaded to the management server 2 on the intranet 120. In the browsing positional information collecting process, information on the positions or places where business data were browsed is collected or obtained. With the browsing system 100 of the illustrative embodiment, the matching process is also performed in which it is examined whether or not the browsing positional information of business data matches up to, or in correspondence with, the authenticated browsing positional information.

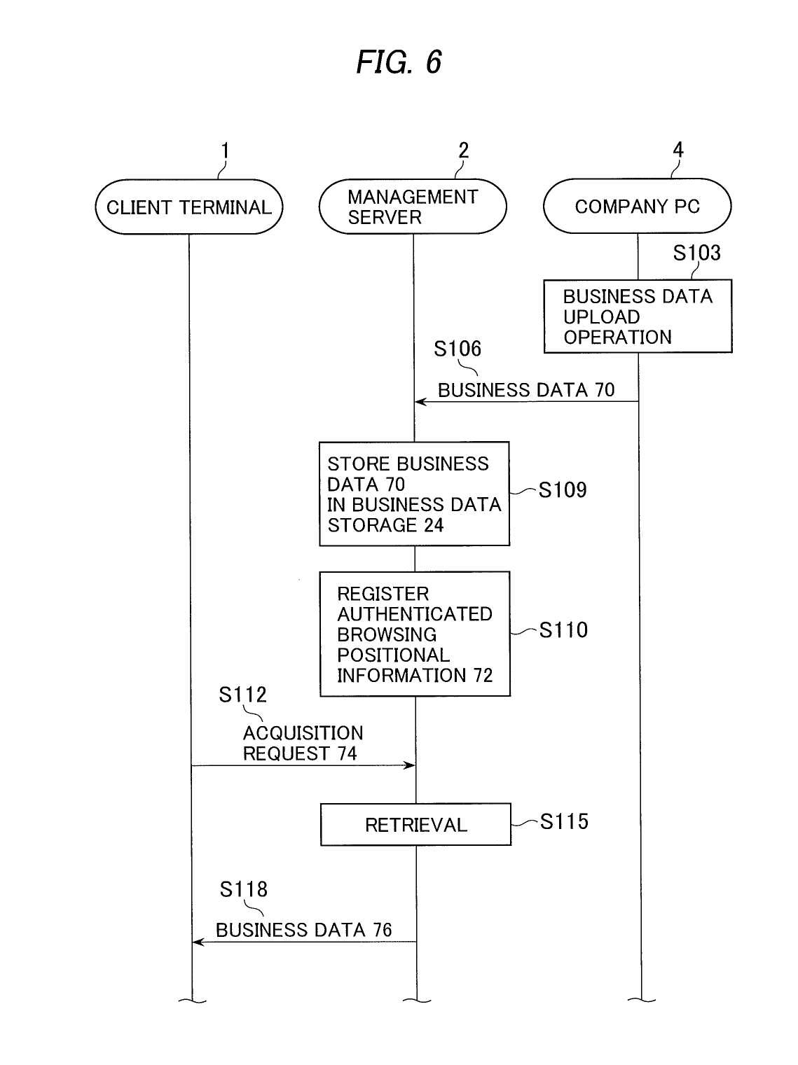

With reference to FIGS. 6, 7 and 8, description will be made on the acquisition process of business data, the browsing positional information collecting process, and the matching process in the order. First, FIG. 6 is a flowchart useful for understanding the acquisition process of business data in the illustrative embodiment. In the figure, a company personal computer 4 first receives the operation of the user for uploading business data at step S103. In the upload operation, the user may, for example, drag and drop the icon of desired business data stored in, and shown on the display 40 of, his or her company personal computer 4 into the window of his or her folder in the management server 2 also shown on the display screen to thereby copy the data. During the upload operation, the user may input and transmit information on attributes regarding business data. The attribute information may include a store attribute, retention period, positional information where browsing is permitted, and the like.

At step S106, the company personal computer 4 transmits business data 70 thus operated for uploading to the management server 2, which is the uploading of business data.

At step S109, the manager 21 of the management server 2 stores the business data 70 transmitted from the company personal computer 4 into the folder, i.e. storage area, prepared for that user in the business data storage 27. In this case, the manager 21 may extract a keyword or index from the business data 140, 150 or 160 and in turn tag the data with the keyword to store the data.

At step S110, the management server 2 registers the authenticated browsing positional information 72 of business data into the authenticated browsing storage 24. The authenticated browsing positional information 72 may be registered in advance by the user or the administrator. Alternatively, from business data uploaded from the company personal computer 4, the authenticated browsing positional information 72 associated therewith may be extracted, and then registered.

At step S112, in the client terminal device 1, the application for utilizing the business data browsing system 100 of the illustrative embodiment is started, and an acquisition request 74 of the business data is transmitted to the management server 2.

At step S115, the retrieval unit 22 of the management server 2 in turn r receives the acquisition request 74 from the client terminal device 1 to search the business data storage 27 for the requested business data. More specifically, the retrieval unit 22 may use the file name and/or keywords which are included in the acquisition request 74 to retrieve the business data. The management server 2 may be responsive to an access from the client terminal device 1 to transmit a list of the business data stored in his or her folder to that client terminal device 1, and retrieval unit 22 may retrieve the business data in question based on the list to transmit the retrieved business data.

Subsequently at step S118, the management server 2 transmits the retrieved business data 76 to the client terminal device 1 which has originated the acquisition request. At that time, if the authenticated browsing positional information is associated with the business data, the management server 2 may transmit the authenticated browsing positional information to the client terminal device 1 together with business data 76.

In the above, the acquisition process of business data in the browsing system 100 of the illustrative embodiment has been described. Next, the browsing process of business data in the browsing system 100 will be described.

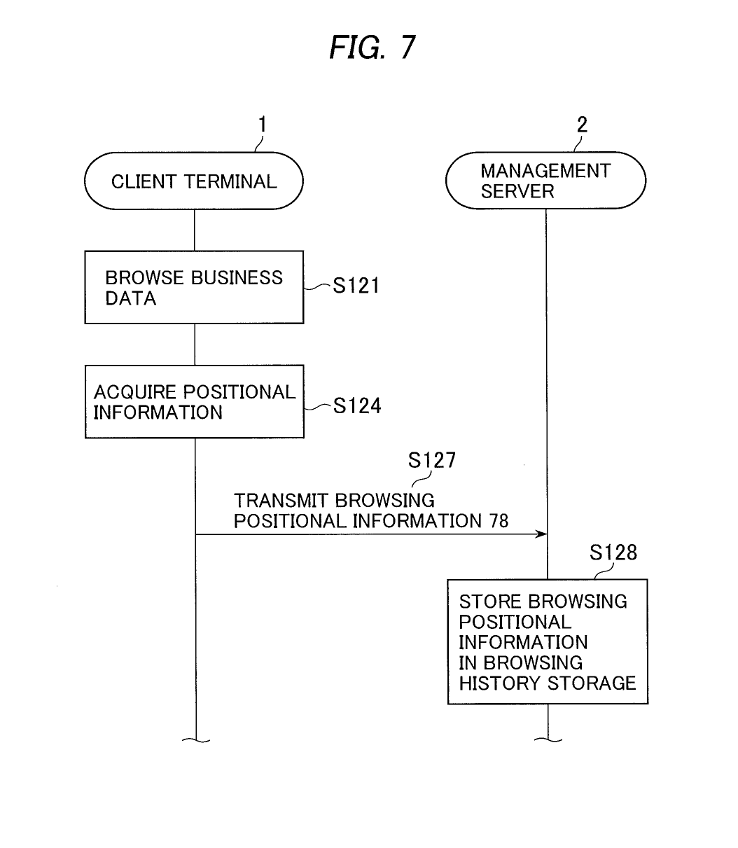

In the illustrative embodiment, the management server 2 collects the browsing positional information on where business data transmitted to the client terminal devices 1 were browsed. With reference to FIG. 7, it will be described how business data are collected in the browsing positional information collecting process of the embodiment.

FIG. 7 is a flowchart useful for understanding the browsing positional information collecting process of business data in the illustrative embodiment. In the figure, at step S121, the browsing controller 17 of the client terminal device 1 is first in response to the browsing operational instruction 58 entered by the user to instruct the display controller 11 to display business data 62 on the display 12.

At step S124, the GPS positioning unit 16 of the client terminal device 1 acquires the information 68 on the current position of the client terminal device 1, and outputs the current positional information 68 to the terminal controller 10.

At step S127, the communication controller 18 of the client terminal device 1 transmits the current positional information 68, which is output from the GPS positioning unit 16, as the browsing positional information 78 of business data toward the management server 2 through the communicator 14.

At step S128, the manager 21 of the management server stores the browsing positional information 78, which represents which business data and where the data were browsed and is transmitted from the client terminal device 1, into the browsing history storage 26.

By those steps, in the browsing system 100 of the illustrative embodiment, the management server 2 can collect the browsing positional information of browsed business data from the client terminal devices 1. The browsing positional information will be utilized for checking the matching with the authenticated browsing positional information.

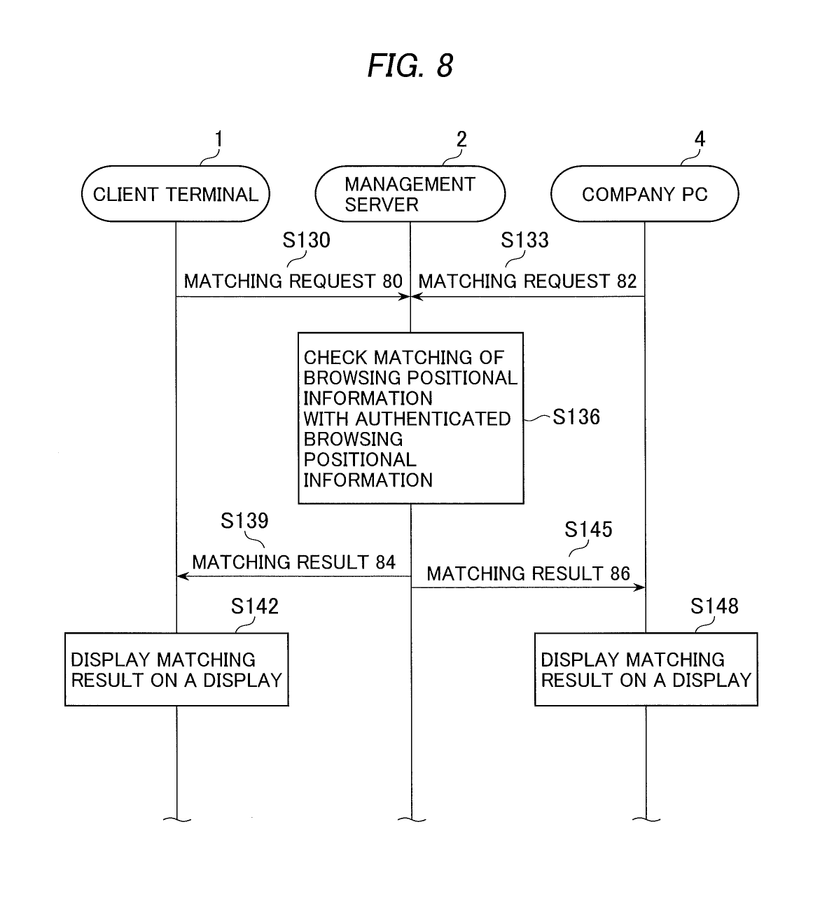

Now, with reference to FIG. 8, the matching process in the illustrative embodiment will be described. FIG. 8 is a flowchart useful for understanding the matching process in the illustrative embodiment. In the figure, at step S130, a client terminal device 1 first sends a matching request to the management server 2. Alternatively, at step S133, the company personal computer 4 may send a matching request to the management server 2.

At step S136, the matching unit 23 of the management server 2 checks whether or not the authenticated browsing positions of business data in question stored in the authenticated browsing storage 24 is correspondent to the browsing positions of those business data stored in the browsing history storage 26. The matching unit 23 may output the matching result, for example, in the form of display on a map at a position or location where the file or business data are/were accessed with at least either of the browsing positional information matching the authenticated browsing positional information and the browsing positional information not matching the authenticated browsing positional information.

At step S139, the management server 2 transmits the matching result 84 to the client terminal device 1 which sent the matching request. Then, at step S142, the client terminal device 1 displays the matching result 84 on the display 12. Accordingly, the user can verify whether or not the business data in question were browsed or presented at the intended position.

Alternatively, at step S145, the management server 2 transmits the matching result 86 to the company personal computer 4 which sent the matching request. Then, at step S148, the company personal computer 4 displays the matching result 86 on the display 40. Accordingly, the administrator can confirm whether or not the business data in question were browsed or accessed) at the intended or appropriate position.

In the above, the matching process in the illustrative embodiment has been described in detail. The matching results 84 and 86 may be presented on a map in the form of browsing positions of authenticating and/or not authenticating the browsing plural items of business data, or in the form of user-by-user.

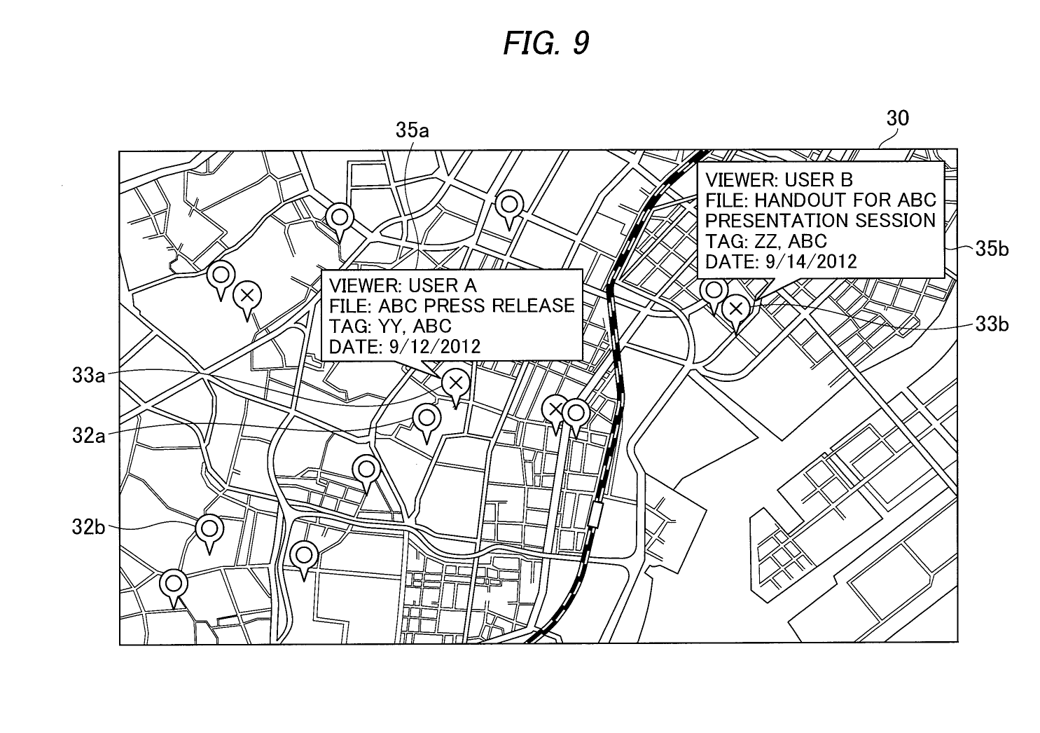

Display examples of the matching result will be described with reference to FIGS. 9, 10 and 11. FIG. 9 shows a display example 30 of the matching result in the illustrative embodiment. As seen from the figure, according to the display example 30, when the browsing position of business data matches the authenticated browsing position, icons 32a and 32b are displayed on a map at positions corresponding to the browsing positions concerned, each icon, having a circle enclosed thereinside, indicating the authenticated browsing. On the contrary, when the browsing position of business data does not match the authenticated browsing position, icons 33a and 33b are displayed on the map at positions corresponding to the browsing positions concerned, each icon, having a cross enclosed thereinside, indicating the unauthenticated browsing.

Accordingly, the user and the administrator can understand intuitively whether or not business data were browsed with authentication and the like, thus advantageously preventing unauthorized access and browsing of the data.

If any of the icons 32 and 33 is pointed out on the display screen by clicking a mouse, for example, the detailed data 35 are displayed. Specifically, as illustrated in FIG. 9, for example, if each of the icons 33a and 33b is pointed out by a cursor clicked, the detailed data 35a and 35b including the file name of the business data, viewer's name, keywords tagged to the business data, and browsing date and time are displayed.

Accordingly, the user and the administrator can understand the file name of the business data browsed with or without authentication, the visitor and so on.

Although the authenticated and unauthenticated icons are displayed in the example shown in FIG. 9, the illustrative embodiment may not be limited to this specific display example. On the map, only the authenticated icons 32 may be displayed, or alternatively only the unauthenticated icons 33 may be displayed.

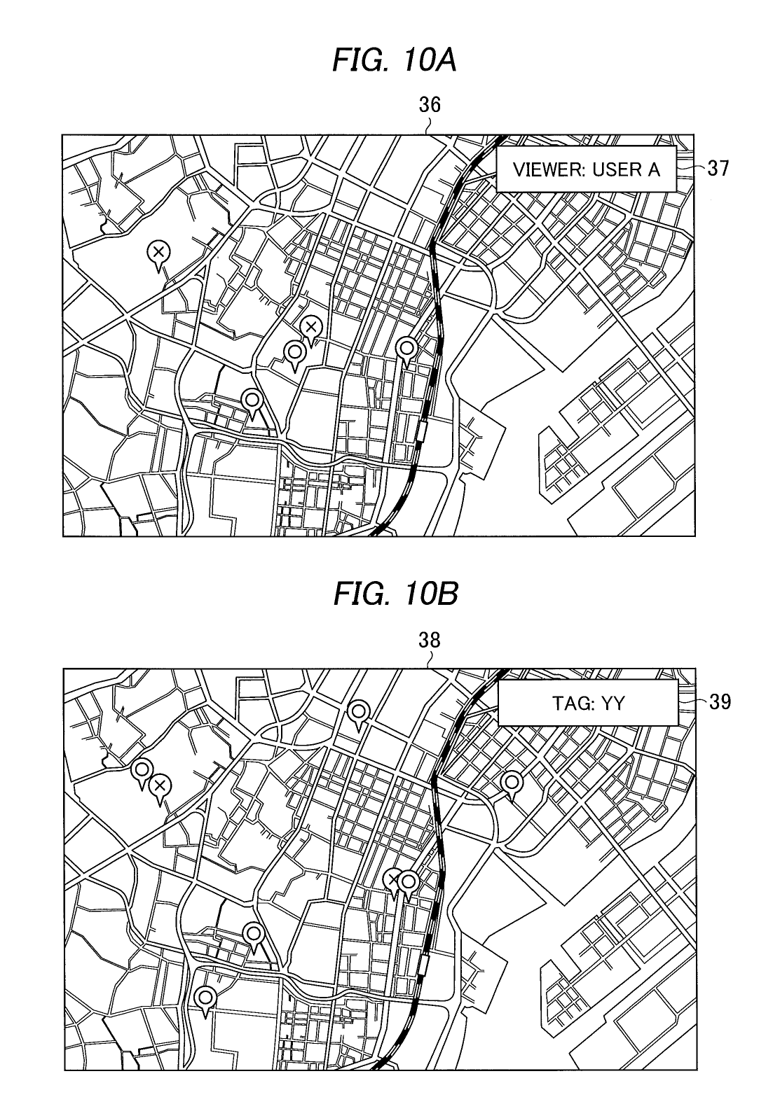

Other display examples 36 and 38 of the matching result in the illustrative embodiment will be described with reference to FIGS. 10A and 10B. As illustrated in FIG. 10A, according to the display example 36, the map includes the icons displayed which indicate the authenticated and unauthenticated browsing of the business data only with respect to the user A having browsed. On the upper right part of the screen of the display example 36, a display field 37 is provided for indicating a viewer, that is, who browsed the business data.

Accordingly, the user and the administrator can intuitively understand authenticated and/or unauthenticated browsing of business data by a particular user, thus advantageously preventing unauthorized access and browsing of the data.

The system may be adapted to display the display example 36 by switching from the display example 30 when the item “visitor: user A” in the detailed data 35 is pointed out by clicking in the display example 30 shown in FIG. 9.

In the display example 38 shown in FIG. 10B, the map shows only the icons indicating authenticated and unauthenticated browsing of the business data tagged with the keyword “YY”. On the upper right part of the display example 38, a display field 39 is provided to indicate the tag.

The user and the administrator can thus intuitively confirm authenticated and/or unauthenticated browsing of business data having a specific tag provided.

The system may be adapted to display the display example 38 by switching from the display example 30 when “tag: YY” in the detailed data 35 is pointed out by clicking in the display example 30 illustrated in FIG. 9.

Another alternative display example of the matching result in the illustrative embodiment will be described. The other alternative display example is directed to business data being of a press release, an explanatory material, a catalog, a brochure or the like regarding products. In the present example, authenticated and/or unauthenticated icons are depicted along with order information on the product being ordered. It is thus possible to understand that an order of the product was received in response to which business data were presented, and to statistically analyze which the probability of receiving orders is higher between the cases of presenting authenticated business data and unauthenticated business data, and so on. The analyses may advantageously be useful for marketing.

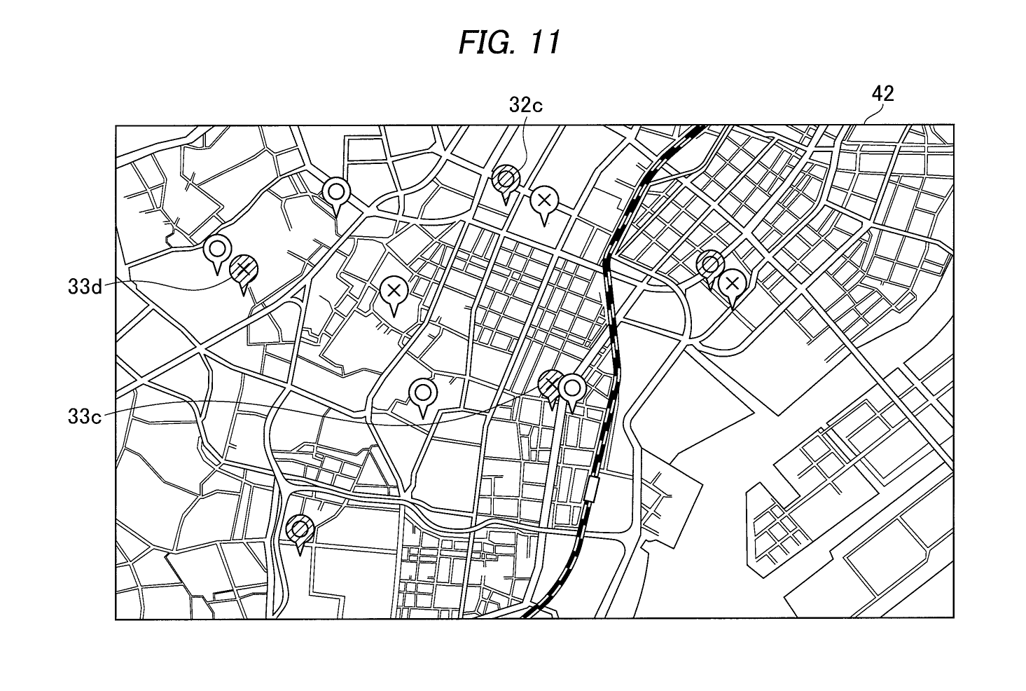

Various ways of displaying authenticated and/or unauthenticated icons together with order information may be available. For example, one of the way is illustrated in FIG. 11, which shows a further alternative display example 42 of the matching result in the illustrative embodiment. As apparent from the figure, the display example 42 includes on a map the icons 32 and 33 indicating authenticated and unauthenticated browsing. Further, the shaded icons correspond to places at which the orders were received.

The user and the administrator can thus intuitively understand authenticated and unauthenticated browsing of business data, as well as the orders of purchasing products received. In place of, or addition to, the shaded icons corresponding to places at which orders were received, the icons may be blinked and/or depicted larger than the icons corresponding to places at which no order was received. Furthermore, the icons corresponding to places at which orders were received may have a star-shaped mark or sign added to indicate “order received”.

According to the example illustrated in FIG. 11, it can be understand that an order of the product was received even though the icons 33c and 33d indicate that business data were accessed or browsed at an unauthenticated place. That analysis may be helpful in planning a future business policy and marketing.

In summary, according to the business data browsing system 100 of the illustrative embodiment, it is possible to obtain the matching result of the browsing positional information of business data.

Specifically, the matching is checked between the browsing position of business data and the authenticated browsing position of the business data concerned. At least either of the business data whose browsing position matches the authenticated browsing position and the business data whose browsing position does not match the authenticated browsing position is displayed at positions on a map in which correspond to those data. The user and the administrator can thus intuitively understand whether or not business data were browsed with authentication, thus advantageously preventing an illegal or unauthorized use of, or access to, business data.

While the present invention has been described with reference to the particular illustrative embodiment, it is not to be restricted by the embodiment. It is to be appreciated that those skilled in the art can change or modify the embodiment without departing from the scope and spirit of the present invention.

For example, the controller 20 may be adapted to automatically produce the authenticated browsing positional information of business data to register the information into the authenticated browsing storage 24. More specifically, the controller 20 may extract character strings, such as a spot name, an address, a telephone number and a postal code number, from the text of business data uploaded from the company personal computers 4, to use the character string concerned to produce the positional information, for example, latitude and longitude, to register the positional information as the authenticated browsing positional information. The controller 20 can thus use the contents of business data to automatically register the authenticated browsing positions.

In the display example of the matching result described with reference to FIGS. 10A and 10B, the icons indicating authenticated and unauthenticated browsing of business data items are displayed on a map for each viewer or for each tag. However, the icons indicating authenticated and/or unauthenticated browsing may be displayed on a map for respective business data items.

The illustrative embodiment of the server and the user terminal device is depicted and described as configured by separate functional blocks, such as the communicator and the controller. It is however to be noted that such a depiction and a description do not restrict the server and the user terminal device to an implementation only in the form of hardware but at least the server and the user terminal device may partially or entirely be implemented by software, namely, by a computer, or processor system, which has a computer program installed and functions, when executing the computer program, as part of, or the entirety of, the server and the user terminal device. In this connection, the word “circuit”, “device” or “unit” may be understood not only as hardware, such as an electronics circuit, but also as a function that may be implemented by software installed and executed on a computer.

According to one embodiment of the present invention, there is provided a non-transitory computer-readable storage medium storing a program, or a program product, for causing a computer to function as components of the server, or for causing a computer to execute the above-described steps performed by the server. According to another embodiment of the present invention, there is provided a non-transitory computer-readable storage medium storing a program, or a program product, for causing a computer to function as components of the user terminal device, or for causing a computer to execute the above-described steps performed by the user terminal device.

The entire disclosure of Japanese patent application No. 2012-209725 filed on Sep. 24, 2012, including the specification, claims, accompanying drawings and abstract of the disclosure, is incorporated herein by reference in its entirety.

What is claimed is:

1. A server comprising:
a collector which collects browsing positional information of a file from a user terminal device;
a matching unit which checks matching of the collected browsing positional information with authenticated browsing positional information of the file to produce a matching result representative of a result of checking; and
an outputter which outputs the matching result.

2. The server in accordance with claim. 1, wherein the matching result is displayed on a map at a position where the file was accessed with at least either of the browsing positional information matching the authenticated browsing positional information and the browsing positional information not matching the authenticated browsing positional information.

3. The server in accordance with claim 1, wherein said collector collects viewer information of a viewer accessing the file.

4. The server in accordance with claim. 3, wherein the matching result is displayed on a map at a position where the file was accessed with at least either of the browsing positional information matching the authenticated browsing positional information and the browsing positional information not matching the authenticated browsing positional information for the viewer.

5. The server in accordance with claim. 1, wherein the matching result is displayed on a map at a position where the file was accessed with at least either of the browsing positional information matching the authenticated browsing positional information and the browsing positional information not matching the authenticated browsing positional information for the file.

6. The server in accordance with claim 1, wherein the file is tagged with a keyword, and
the matching result is displayed on a map at a position where the file was accessed with at least either of the browsing positional information matching the authenticated browsing positional information and the browsing positional information not matching the authenticated browsing positional information for the keyword.

7. The server in accordance with claim 1, wherein the file includes data regarding business of a sales product, and
the matching result is displayed on a map at a position where the file was accessed with at least either of the browsing positional information matching the authenticated browsing positional information and the browsing positional information not matching the authenticated browsing positional information together with information of an order received on the product.

8. A user terminal device comprising:
a browsing controller operative in response to operation of a user for controlling browsing of a file;
a positional information acquisition unit which acquires current positional information representative of a position where the file is browsed by said user terminal device; and
a transmission controller which controls said positional information acquisition unit to transmit the current positional information to a server as browsing positional information on the file.

9. The user terminal device in accordance with claim 8, wherein said device receives a matching result from the server,
said device further comprising a display controller which uses the matching result to display on a map at a position where the file was accessed with at least either of the browsing positional information matching the authenticated browsing positional information of the file and the browsing positional information not matching the authenticated browsing positional information.

10. A non-transitory computer-readable storage medium storing a program for causing a computer to function as:
a collector which collects browsing positional information of a file from a user terminal device;
a matching unit which checks matching of the collected browsing positional information with authenticated browsing positional information of the file to produce a matching result representative of a result of checking; and
an outputter which outputs the matching result.

11. A non-transitory computer-readable storage medium storing a program for causing a computer to function as:
a browsing controller operative in response to operation of a user for controlling browsing of a file;
a positional information acquisition unit which acquires current positional information representative of a position where the file was browsed by a user terminal device; and
a transmission controller which controls the positional information acquisition unit to transmit the current positional information to a server as browsing positional information of the file.
